(19) United States
(12) Patent Application Publication
(10) Pub. No.: US 2013/0297512 A1
(43) Pub. Date: Nov. 7, 2013

(54) CARDHOLDER VERIFICATION RULE APPLIED IN PAYMENT-ENABLED MOBILE TELEPHONE

(71) Applicant: MasterCard International Incorporated, Purchase, NY (US)

(72) Inventors: Simon Phillips, York (GB); James J. Anderson, Mount Vernon, NY (US); Murdo Munro, Hove (GB)

(21) Appl. No.: 13/931,025

(22) Filed: Jun. 28, 2013

Related U.S. Application Data
(63) Continuation of application No. 12/578,289, filed on Oct. 13, 2009.

(51) Int. Cl. G06Q 20/40

(52) U.S. Cl. CPC G06Q 20/409
USPC 705/44

(57) ABSTRACT

A method includes a cardholder device receiving at least one cardholder verification rule from a computer, and storing the cardholder verification rule. The cardholder verification rule prescribes circumstances under which a cardholder is required to perform a cardholder verification process in connection with a purchase transaction. The method includes the cardholder device receiving purchase transaction information from a merchant device, and then determining by using the stored cardholder verification rule, and based on at least one of the received purchase transaction information and current circumstances, that cardholder verification is not required. The cardholder device then uploads payment information to the merchant device to complete the purchase transaction.

### CROSS-REFERENCE TO RELATED APPLICATION

This application claims the benefit of U.S. patent application Ser. No. 12/578,289 filed on Oct. 13, 2009 and U.S. Provisional Patent Application No. 61/163,532, filed Mar. 26, 2009, each of which are incorporated herein by reference.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

From the point of view of transaction security, it has been conventional to verify the identity of the individual who presents the payment card by requiring the individual to provide his signature, which can then be compared with the signature borne on the reverse side of the payment card. As another cardholder verification method (CVM), the cardholder may be required to enter a personal identification number (PIN) into the POS terminal. The POS terminal may then engage in online communication with a computer operated by the issuer of the payment card to verify the correctness of the PIN entered by the customer.

In pursuit of still greater convenience and more rapid transactions at POS terminals, payment cards have more recently been developed that allow the account number to be automatically read from the card by radio frequency communication between the card and a so-called “proximity reader” which may be incorporated with the POS terminal. In such cards, often referred to as “proximity payment cards” or “contactless payment cards”, a radio frequency identification (RFID) integrated circuit (IC, often referred to as a “chip”) is embedded in the card body. A suitable antenna is also embedded in the card body and is connected to the RFID chip to allow the chip to receive and transmit data by RF communication via the antenna. In typical arrangements, the RFID chip is powered from an interrogation signal that is transmitted by the proximity reader and received by the card antenna.

MasterCard International Incorporated, the assignee hereof, has established a widely-used standard, known as “PayPass”, for interoperability of contactless payment cards and proximity readers. It has also been proposed to use wireless exchanges of information via NFC (Near Field Communication) for payment applications.

CVM practices, as described above, that were utilized with mag stripe payment cards have also been applied with contactless payment cards. However, and again in the interest of streamlining transactions at the point of sale, rules have been implemented such that transactions having a monetary amount below a certain limit do not require CVM. For example, according to one conventional rule, no PIN entry is required for transactions in an amount of $25.00 or less; for transactions of a greater amount, PIN entry into the POS terminal is still required to support online verification of the PIN via the issuer's computer. Conventionally, such a rule is programmed into and enforced by the POS terminal.

According to another variation, made possible by the processing capabilities of contactless payment cards, a PIN that is entered into the POS terminal is communicated by RF from the POS terminal to the contactless payment card for so-called “offline PIN verification” by the card. The card then communicates by RF back to the POS terminal to indicate whether the PIN was correct.

It has been proposed that the capabilities of a contactless payment card be incorporated into a mobile telephone, thereby turning the mobile telephone into a contactless payment device. Typically a mobile telephone/contactless payment device includes integrated circuitry with the same functionality as the RFID IC of a contactless payment card. In addition, the mobile telephone/contactless payment device includes a loop antenna that is coupled to the payment-related IC for use in sending and/or receiving messages in connection with a transaction that involves contactless payment.

The present inventors have now recognized opportunities for providing greater flexibility in the setting and application of rules which determine whether CVM is required for a given retail purchase transaction.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 schematically illustrates personalization of a mobile telephone for payment enablement purposes.

FIG. 2 schematically illustrates use of a payment-enabled mobile telephone for a purchase transaction at a POS terminal.

FIG. 3 is a block diagram that illustrates an example embodiment of the mobile telephone shown in FIGS. 1 and 2.

FIG. 4 is a flow chart that illustrates a process that may be performed in the mobile telephone of FIG. 3 in accordance with aspects of the present invention.

FIG. 5 is a block diagram that illustrates an issuer server computer shown in FIG. 1.

FIG. 6 is a flow chart that illustrates a process performed by the issuer server computer of FIG. 5 in accordance with aspects of the present invention.

FIG. 7 is a flow chart that illustrates another process performed by the issuer server computer in accordance with aspects of the present invention.

### DETAILED DESCRIPTION

In general, and for the purpose of introducing concepts of embodiments of the present invention, embodiments relate to payment card systems in which mobile telephones are provided with payment capabilities so as to be able to function as proximity payment devices. A financial institution that issues payment card accounts may choose to apply different cardholder verification procedures to various categories of its cardholder-customers. For example, upscale cardholders may be relieved of performing cardholder verification (e.g., entry of a PIN) for transactions of a type for which other cardholders are required to perform cardholder verification. To implement this policy, the financial institution may, during personalization of mobile telephones for use as proximity payment devices, load varying rules as to circumstances for which cardholder verification is required.

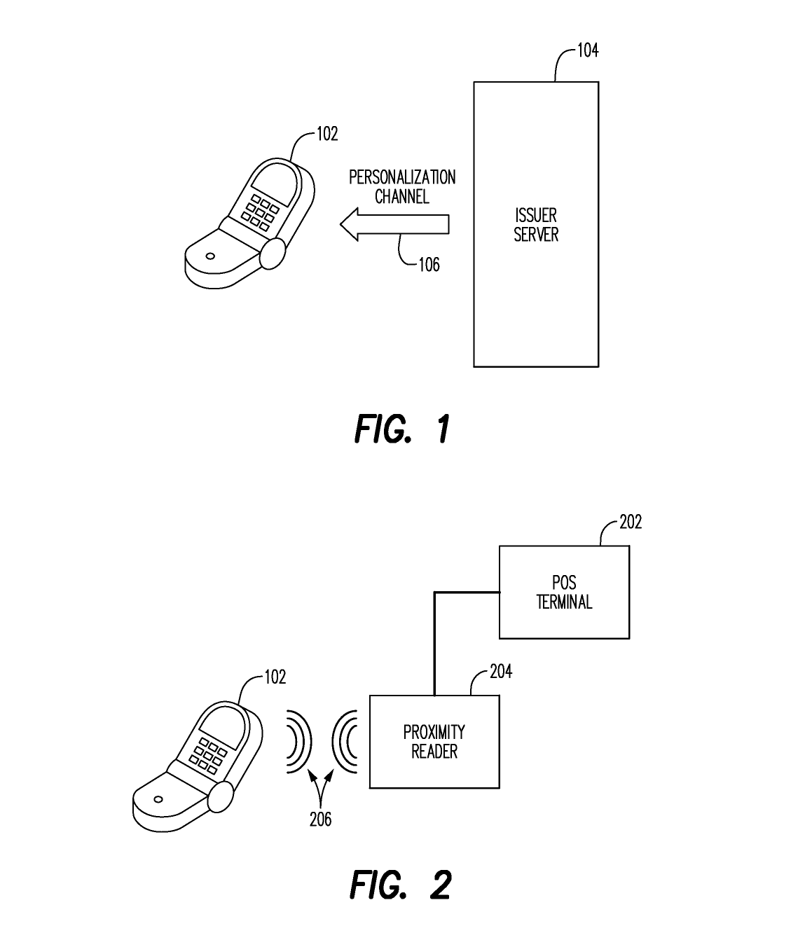

FIG. 1 schematically illustrates personalization of a mobile telephone 102 for payment enablement purposes. Block 104 in FIG. 1 represents a server computer operated by or on behalf of an issuer (financial institution) of payment card accounts. The server computer 104 is the source of information that is loaded into the mobile telephone 102 for the purpose of “personalizing” the mobile telephone 102. Arrow 106 schematically illustrates a communication channel by which the personalization information is transmitted from the server computer 104 to the mobile telephone 102.

As is familiar to those who are skilled in the art, “personalization” refers to the process by which user- and/or account-specific information is loaded into and/or otherwise applied to a payment device (e.g., a contactless payment card or payment-enabled mobile telephone or mag stripe payment card). In connection with traditional mag stripe payment cards, the personalization process includes magnetically storing the cardholder's name and the payment card account number and other information on the mag stripe, and also printing/embossing the cardholder's name and account number, etc., on the plastic body of the card. For a conventional contactless payment card, personalization may include similar printing or embossing, plus storage of cardholder name and account number and other information by RF wireless communication into an integrated circuit (IC) embedded in the body of the contactless payment card.

Personalization of a payment-enabled mobile telephone also entails storage of information in an IC contained within the phone. According to one conventional proposal, the information is communicated to the mobile telephone over the air (OTA) via the mobile communication network by a data communication session between the mobile telephone and the issuer's server. It has also been proposed that personalization of the mobile telephone may include downloading to the mobile telephone of a so-called “payment application”, which is a software program that controls the mobile telephone to provide its payment functionality.

The above-mentioned OTA communication channel may be one embodiment of the personalization channel 106 shown in FIG. 1. According to another proposal (and as disclosed in co-pending and commonly assigned U.S. patent application Ser. No. 11/870,144—published as U.S. Publication No. 2009/0100511), the personalization information for a particular user's mobile telephone is loaded into a contactless IC card from the issuer's server computer and then the contactless IC card is sent to the user. The user/cardholder then brings the contactless IC card into proximity with the mobile telephone to permit loading of the personalization information via RF communication from the IC card to the mobile telephone. This technique is another possible embodiment of the personalization channel 106 shown in FIG. 1. The contactless IC card described in this paragraph, into which programs and/or data are loaded to in turn be loaded into a mobile telephone or other device, may hereinafter be referred to as a “personalization card” or “perso card”, for short.

In other embodiments, the personalization channel 106 may be constituted by any other personalization technique previously or hereafter proposed.

In accordance with aspects of the present invention, the personalization information loaded into the mobile telephone 102 from the issuer server 104 via the personalization channel 106 may include at least one cardholder verification rule to be applied by the mobile telephone 102 in connection with purchase transactions performed with the mobile telephone 102. It will be understood that a “cardholder verification rule” is a rule that prescribes when and/or under what circumstances the user/cardholder is required to perform a cardholder verification process. Further details and examples of cardholder verification rules will be discussed below.

FIG. 2 schematically illustrates use of the mobile telephone 102 for a purchase transaction at a POS terminal 202. In particular, the mobile telephone 102 may interact with the POS terminal 202 via a proximity reader 204 that is incorporated in and/or associated with the POS terminal 202. Wireless RF communication between the proximity reader 204 and the mobile telephone 102 is schematically illustrated at 206. However, in many practical embodiments, the communication 206 may occur as and when the housing of the mobile telephone 102 is tapped by the user on the housing of the proximity reader 204.

The POS terminal 202 and the proximity reader 204 may be of conventional construction and may operate in a conventional manner, except that, for example, the POS terminal 202 may not be programmed to apply any rule with respect to cardholder verification, or the POS terminal 202 may allow any cardholder verification rule programmed therein to be overridden upon receiving communication from the mobile telephone 102 that indicates that the mobile telephone 102 is programmed with a cardholder verification rule. Further, the POS terminal 202 and the proximity reader 204 may transmit to the mobile telephone information that the mobile telephone needs to apply a cardholder verification rule. In some embodiments, the POS terminal/proximity reader may provide this information automatically to the mobile telephone. In other embodiments, the POS terminal/proximity reader may provide this information to the mobile telephone in response to a request or indication from the mobile telephone that it needs the information.

The proximity reader 204 and the mobile telephone 102 may, for example, communicate with each other in accordance with the above-mentioned PayPass standard.

Further details of the interaction between the POS terminal 202/proximity reader 204 and the mobile telephone 102 will be described below.

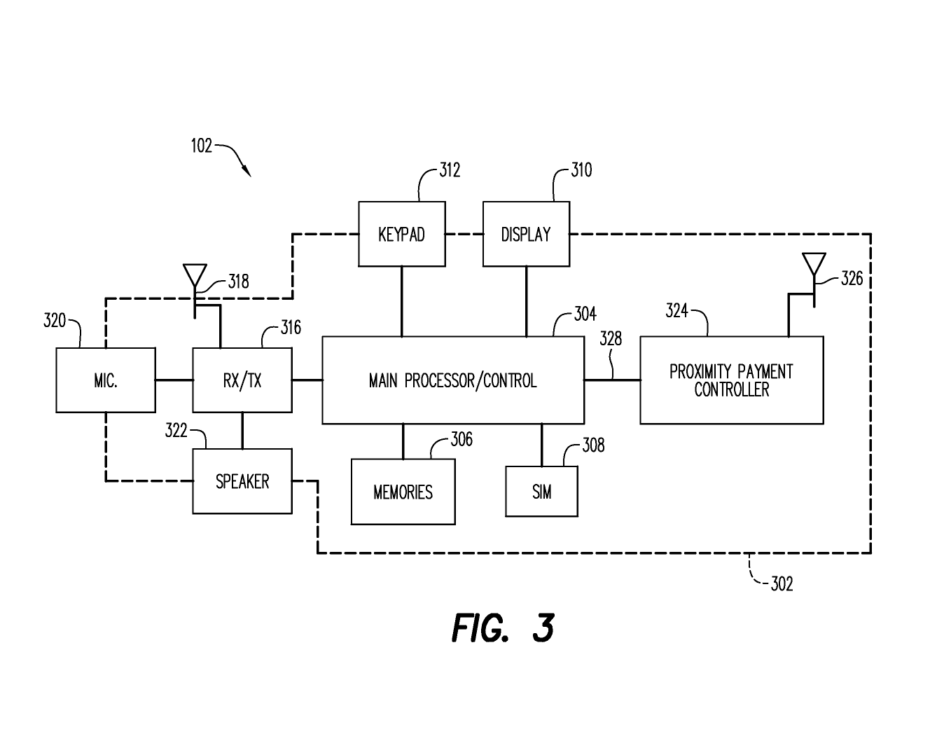

FIG. 3 is a block diagram representation of the mobile telephone 102, as provided in accordance with aspects of the present invention. The mobile telephone 102 may be conventional in its hardware aspects.

The mobile telephone 102 may include a conventional housing (indicated by dashed line 302 in FIG. 3) that contains and/or supports the other components of the mobile telephone 102. The housing 302 may be shaped and sized to be held in a user's hand, and may for example fit in the palm of the user's hand.

The mobile telephone 102 further includes conventional control circuitry 304, for controlling over-all operation of the mobile telephone 102. Other components of the mobile telephone 102, which are in communication with and/or controlled by the control circuitry 304, include: (a) one or more memory devices 306 (e.g., program and working memory, etc.); (b) a conventional SIM (subscriber identification module) card 308; (c) a keypad 312 for receiving user input; and (d) a conventional display component 310 for displaying output information to the user. For present purposes the keypad 312 will be understood to include, e.g., a conventional 12-key telephone keypad, in addition to other buttons, switches and keys, such as a conventional rocker-switch/select key combination, soft keys, and send and end keys.

The mobile telephone 102 also includes conventional receive/transmit circuitry 316 that is also in communication with and/or controlled by the control circuitry 304. The receive/transmit circuitry 316 is coupled to an antenna 318 and provides the communication channel(s) by which the mobile telephone 102 communicates via the mobile telephone communication network (not shown). The receive/transmit circuitry 316 may operate both to receive and transmit voice signals, in addition to performing data communication functions, such as GPRS communications.

The mobile telephone 102 further includes a conventional microphone 320, coupled to the receive/transmit circuitry 316. Of course, the microphone 320 is for receiving voice input from the user. In addition, a loudspeaker 322 is included to provide sound output to the user, and is coupled to the receive/transmit circuitry 316.

In conventional fashion, the receive/transmit circuitry 316 operates to transmit, via the antenna 318, voice signals generated by the microphone 320, and operates to reproduce, via the loudspeaker 322, voice signals received via the antenna 318. The receive/transmit circuitry 316 may also handle transmission and reception of text messages and other data communications via the antenna 318.

The mobile telephone 102 may also include a payment circuit 324 and a loop antenna 326, coupled to the payment circuit 324. The payment circuit 324 may include functionality that allows the mobile telephone 102 to function as a contactless payment device. In some embodiments, the payment circuit 324 includes a processor (not separately shown) and a memory (not separately shown) that is coupled to the processor and stores program instructions for controlling the processor. Although shown as separate from the main processor 304, the payment circuit 324 and/or its processor component may be integrated with the main processor 304. In accordance with conventional practices, and in accordance with some embodiments, the mobile telephone may include a so-called “secure element” (not separately shown), which may be incorporated with the payment circuit 324, the main processor 304 or the SIM card 308. As is familiar to those who are skilled in the art, the secure element may be constituted with a small processor and volatile and nonvolatile memory that are secured from tampering and/or reprogramming by suitable measures. The secure element may, for example, manage functions such as storing and reading out a payment card account number, and cryptographic processing. Moreover, and in accordance with aspects of the present invention, the secure element may store and apply a cardholder verification rule and may handle receipt and verification of cardholder verification input (such as entry of a PIN). The payment circuit 324 may be in communication with the control circuitry 304 via a data communication connection 328.

Referring again to FIG. 1, the issuer server 104 may be conventional in terms of its hardware. That is, as will be appreciated by those who are skilled in the art, the issuer server 104 may include one or more computer processors, and program memory or other storage devices in communication with the processors and storing program instructions for controlling the processors. The issuer server 104 may also include communication ports by which the issuer server may engage in data communication with other devices. For example, the communication ports may allow the issuer server to transmit personalization information to mobile telephones or other payment-enabled devices.

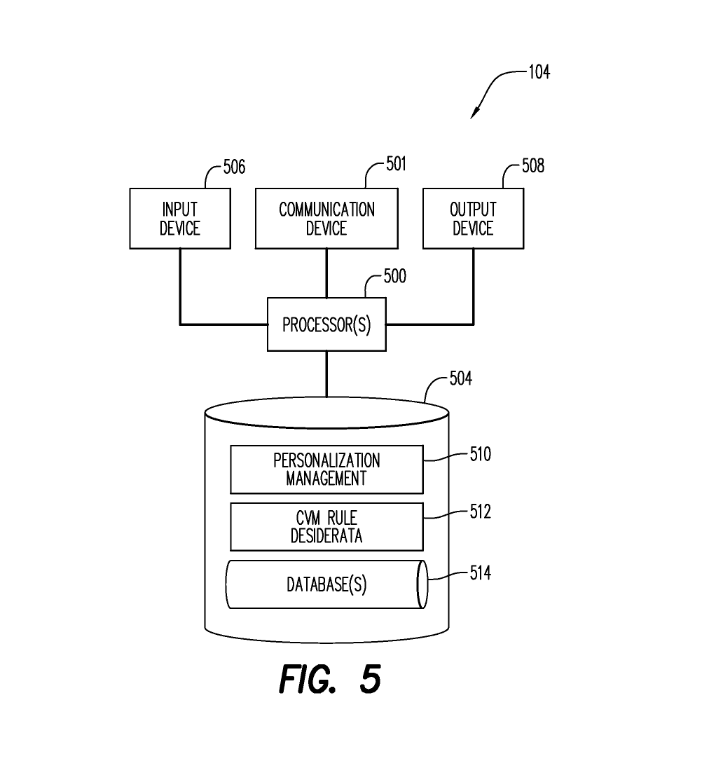

In general, the issuer server 104 may operate in a conventional manner. However, in accordance with aspects of the present invention, and with the inventive concept of storing and applying cardholder verification rules in payment-enabled mobile telephones, the issuer server may set different cardholder verification rules for different cardholders, and may download the various rules on a selective basis as part of the personalization information for the payment-enabled mobile telephones. Further details of the issuer server 104 and its operation will be described below with reference to FIGS. 5-7.

To provide an overview of operation of the issuer server 104, it may assign cardholder verification rules on a cardholder-by-cardholder basis and/or may assign different cardholder verification rules for application to different categories or classes of cardholders.

In one example, relatively low-income and/or low-usage cardholders may be assigned a cardholder verification rule that requires entry of a PIN for each transaction that exceeds $25.00. Meanwhile, for higher income cardholders, the assigned cardholder verification rule may dispense with PIN entry for transactions up to a higher dollar amount, say $100.00 or $200.00.

In addition or as an alternative to setting the cardholder verification rule based on the cardholder's income level and/or level of usage of his/her payment card account, the issuer server may set the cardholder verification rule based on one or more of the cardholder's credit history, credit rating, account balance, or as a feature of the card product itself, e.g., based on the amount of annual fee associated with the card product.

For example, and in connection with personalizing a particular mobile telephone, the issuer server may determine a category to which the cardholder belongs, select a cardholder verification rule based on the category of the cardholder, and transmit the selected cardholder verification rule for storage in the mobile telephone as part of the process of personalizing the mobile telephone.

In another example, the issuer server may dynamically change the cardholder verification rule stored in a particular payment-enabled mobile telephone in response to changing conditions. For example, suppose that a fraud detection account surveillance function has detected possible fraudulent activity in connection with a particular payment card account. Then, in response to the possible fraud, the issuer server may download a new cardholder verification rule over-the-air to the cardholder's mobile telephone, such that, according to the new rule, PIN entry is required in all transactions.

Other cardholder verification rules that may be set by the issuer server and loaded via personalization into the payment-enabled mobile telephone, may include the following:

(A) A rule that requires PIN entry for transactions at certain times of day, but not others.

(B) A rule that requires PIN entry for transactions on certain days of the week, but not others.

(C) A rule that requires PIN entry for transactions with certain categories of merchants, but not others.

(D) A rule that requires PIN entry for transactions in certain geographic locations, but not others.

(E) A rule that does not require PIN entry for the first N transaction on a given day, but that requires PIN entry for further transactions during the day.

(F) A rule that requires PIN entry for the first transaction on a given day, but not for later transactions on that day.

(G) A rule that requires PIN entry on each transaction on a given day after a cumulative dollar amount of transactions have been performed by the payment-enabled mobile telephone on that day.

(H) A rule that requires PIN entry for certain types of transactions (e.g., cash back transactions) but not others.

In some embodiments, the issuer server may set the cardholder verification rule for a particular cardholder in accordance with a preference selected by the cardholder. Thus, in these embodiments, the cardholder may provide input to the issuer as to what level of security precaution is to be employed with respect to cardholder verification for the cardholder's account.

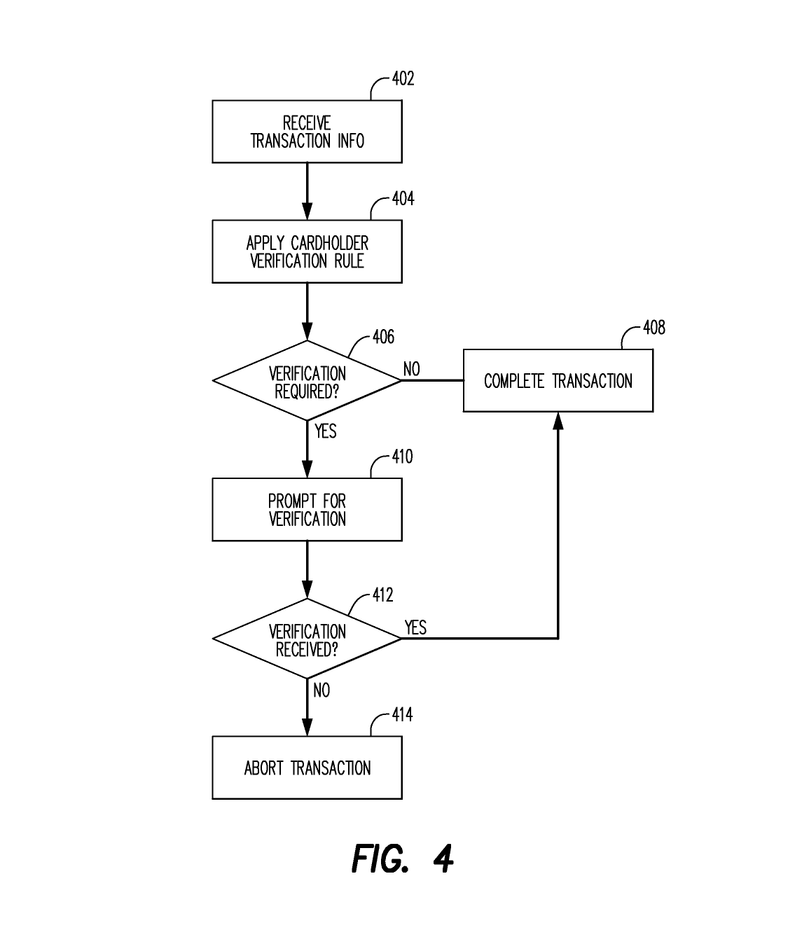

FIG. 4 is a flow chart that illustrates a process that may be performed in the mobile telephone 102 in connection with a retail purchase transaction (as illustrated in FIG. 2) and in accordance with aspects of the present invention. The functionality illustrated in FIG. 4 and described in the ensuing text may be provided by one or more processors in the mobile telephone 102, operating under the control of program instructions stored in one or more memory devices in the mobile telephone 102.

At 402 in FIG. 4, the mobile telephone 102 receives from the POS terminal information concerning the current transaction. This may occur via wireless RF communication between the mobile telephone 102 and the proximity reader 204 as the mobile telephone 102 is being tapped by the cardholder on the proximity reader 204. For example, the transaction information received by the mobile telephone 102 from the POS terminal may indicate the monetary amount of the transaction.

At 404, the mobile telephone 102 may apply a cardholder verification rule that was stored in the mobile telephone 102 (e.g., in the above-mentioned secure element) during personalization of the mobile telephone 102. Examples of possible cardholder verification rules have been described above. For purposes of the present discussion, it will be assumed that the cardholder verification rule calls for PIN entry for transactions in excess of a given dollar amount, and does not require cardholder verification for smaller dollar amount transactions.

At decision block 406, the mobile telephone 102 determines whether the cardholder verification rule in question calls for performance of a cardholder verification process under the current circumstances. For the example as currently described herein, the determination is whether the dollar amount of the current transaction is above or below the dollar amount limit stated in the cardholder verification rule.

If a negative determination is made at decision block 406 (i.e., if the mobile telephone 102 determines that the cardholder verification rule does not require cardholder verification for the current transaction), then the process advances from decision block 406 to block 408. At 408, the transaction is completed in a conventional manner, and without requiring cardholder verification. For example, the mobile telephone 102 may respond to the negative determination at decision block 406 by uploading the cardholder's payment card account number to the POS terminal and by taking any other steps (e.g., generation of a CVC3) customarily required other than cardholder verification.

If a positive determination is made at decision block 406 (i.e., if the mobile telephone 102 determines that the cardholder verification rule requires cardholder verification for the current transaction), then the process advances from decision block 406 to block 410. At 410, the mobile telephone 102 prompts the user/cardholder to perform a cardholder verification process. In the particular example that is described herein, it is assumed that the required verification is entry of the cardholder's PIN, and accordingly step 410 involves, in this example, prompting the user/cardholder to enter his/her PIN. (This may be done by the user entering the PIN via the keyboard of the mobile telephone 102.)

Decision block 412 follows block 410. At decision block 412, the mobile telephone 102 determines whether the user has properly complied with the required cardholder verification process. In the particular example described herein, the determination made by the mobile telephone 102 is as to whether the user has properly entered the cardholder's PIN.

If a positive determination is made at decision block 412 (i.e., in the particular example, if the mobile telephone 102 determines that the PIN was properly entered), then the process advances from decision block 412 to block 408, at which the mobile telephone 102 completes the purchase transaction. For example, the cardholder may again tap the mobile telephone 102 on the proximity reader and at this second tap the mobile telephone 102 may upload the cardholder's payment card account number to the POS terminal via wireless RF communication, and may perform any other steps customarily required of a contactless payment device.

If a negative determination is made at decision block 412 (i.e., if the mobile telephone 102 determines that the user has not properly performed the cardholder verification process), then the process of FIG. 4 advances from decision block 412 to block 414. At block 414, the mobile telephone 102 aborts the transaction. For example, in aborting the transaction, the mobile telephone 102 may refrain from uploading the cardholder's payment card account number to the POS terminal (even if the user repeatedly taps the mobile telephone 102 on the proximity reader), and also may display a message to the user to indicate that the transaction is aborted.

In the above example, it was assumed that the cardholder verification process called for entry of the cardholder's PIN. However, other or additional cardholder verification processes are possible. For example, the cardholder verification process may be or include the mobile telephone 102 receiving biometric input from the user. In one such example, the mobile telephone 102 incorporates a fingerprint reader, and the user is prompted to present his/her fingertip/thumb to the fingerprint reader to comply with the required cardholder verification process. In another example, the mobile telephone 102 includes a pad that is able to receive handwritten input via the user's operation of a stylus, and the user is prompted to operate a stylus to enter his/her signature into the stylus pad to comply with the required cardholder verification process.

As will be understood from previous discussion, the cardholder verification rule may require performance of a cardholder verification process depending on (a) the monetary amount of the current transaction, (b) the current time of day, (c) the current day of the week, (d) the cumulative monetary amount of transactions performed by the mobile telephone on the current day (or during a longer or shorter time period), (e) the cumulative number of transactions performed by the mobile telephone on the current day (or during a longer or shorter time period), (f) a category or identity of the merchant with whom the current transaction is being performed, (g) the current location of the mobile telephone, (h) whether the cardholder verification process was previously performed during the current day (or during a longer or shorter period of time), and/or (i) what type of transaction is currently being performed.

The mobile telephone may receive and/or generate and/or store the information that it needs in order to apply the cardholder verification rule that it stores. As indicated above, if the rule is based on the monetary amount of the transaction, the mobile telephone may receive that information from the POS terminal. If the rule is based on the identity and/or category of the merchant for the current transaction, that information may be provided to the mobile telephone by the POS terminal. Where the rule is based on time of day or day of the week, the mobile telephone may generate that information via a day/time/calendar function included in the mobile telephone, and/or may receive the information from the mobile network by which it operates for telecommunication purposes.

If the rule is based on cumulative monetary amounts or numbers of transactions in a given period, the mobile telephone may track and store the relevant cumulative information, and may, as before, receive the information concerning the monetary amounts of the transactions from the POS terminals with which the transactions are performed.

If the rule is based on the type of transaction, this information may be provided to the mobile telephone from the POS terminal.

If the rule is based on the current location of the mobile telephone (e.g., which country the mobile telephone is currently located in) this information may be provided to the mobile telephone by the mobile network with which it is operating or may be generated by a GPS function incorporated in the phone.

In some embodiments, the user/cardholder may be well aware of the cardholder verification rule stored in and applied by his/her mobile telephone, and may proactively enter his/her PIN when required by the rule and before he/she taps the mobile telephone on the proximity reader, so that prompting the user to enter the PIN and a second tapping of the phone on the proximity reader are not necessary for the transaction in question. In other cases, the user may tap once, be prompted to enter his/her PIN by the mobile telephone's application of the rule, and then enter his/her PIN and tap the phone on the proximity reader again to complete the transaction.

FIG. 5 is a block diagram that illustrates an example embodiment of the issuer server 104, which may operate, as described above and below, in accordance with aspects of the present invention.

The issuer server 104 may be conventional in its hardware aspects but may be controlled by software to cause it to operate in accordance with aspects of the present invention.

The issuer server 104 may include a computer processor 500 operatively coupled to a communication device 501, a storage device 504, an input device 506 and an output device 508.

The computer processor 500 may be constituted by one or more conventional processors. Processor 500 operates to execute processor-executable steps, contained in program instructions described below, so as to control the issuer server 104 to provide desired functionality. The program instructions may be referred to as computer readable program code means.

Communication device 501 may be used to facilitate communication with, for example, other devices (such as the mobile telephones to be personalized by interaction with the issuer server 104).

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be referred to as a computer usable medium.

Storage device 504 stores one or more programs for controlling processor 500. The programs comprise program instructions that contain processor-executable process steps of issuer server 104, including, in some cases, process steps that constitute processes provided in accordance with principles of the present invention, as described in more detail below.

The programs may include an application 510 that programs the issuer server 104 to manage personalization of mobile telephones (and possibly other payment devices as well) authorized by the issuer to access payment card accounts issued by the issuer. The issuer server 104 may perform conventional personalization functions in addition to the operations described herein.

In addition the programs stored in the storage device 504 may include an application 512 that programs the issuer server 104 to determine—on an account by account basis—what cardholder verification rules should apply to the transactions performed for the payment card accounts issued by the issuer.

Storage device 504 may also store one or more databases 514 that contain data required for operation of the issuer server 104. For example, the databases 514 may include a cardholder database (not separately shown) that contains information to indicate for each cardholder a category to which the issuer has assigned the cardholder.

There may also be stored in storage device 504 other unshown elements that may be necessary for operation of the issuer server 104, such as an operating system, a database management system, communication software, other applications, other data files, device drivers, etc.

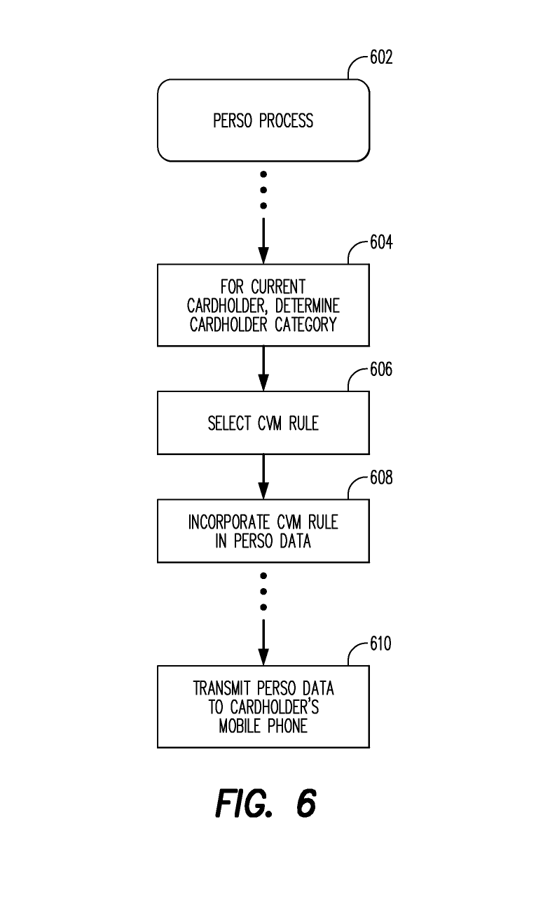

FIG. 6 is a flow chart that illustrates a process performed by the issuer server 104 in accordance with aspects of the present invention.

At 602 in FIG. 6, the issuer server 104 begins performing a personalization process with respect to a particular mobile telephone or other device that is or is going to be provided with proximity payment capabilities. The personalization process may, as described above with respect to FIG. 1, involve the issuer server 104 engaging in an OTA data communication session with the mobile telephone 102 depicted in FIG. 1. The OTA session may be initiated by the mobile telephone 102 or by the issuer server 104. Alternatively, the personalization process may involve the issuer server 104 controlling suitable personalization equipment to load data and/or programs into a perso card (not shown) that is to be used to load payment-related data and/or programming into the mobile telephone 102.

At 604 in FIG. 6, the issuer server 104 accesses a database entry for the cardholder whose mobile telephone is to be personalized. In so doing, the issuer server 104 determines what category has been assigned to the cardholder in question. Then, at 606, the issuer server 104 selects a CVM rule that is to be loaded into the cardholder's mobile telephone as part of the personalization process. To reiterate an example provided above, for cardholders who have been assigned to an upscale category, the issuer server 104 may select a CVM rule that allows transactions of less than $100.00 to proceed without requiring CVM and that requires CVM to be performed for transactions of $100.00 or more. However for ordinary (i.e., non-upscale) cardholders, the issuer server 104 may select a CVM rule that requires CVM to be performed for transactions of $25.00 or more.

At 608, the issuer server 104 incorporates the selected CVM rule in data that is to be loaded into the mobile telephone 102 as part of the personalization process. Other such data, or related programs, may include the cardholder's payment card account number, name, expiration date, a payment application, etc.

At 610, the issuer server 104 transmits the personalization data, including the selected CVM rule, to the mobile telephone 102. This may be done via the above-mentioned OTA data communication session, or by loading the perso data into a perso card and sending the perso card to the cardholder, or by any other technique employed to personalize a mobile telephone or similar device.

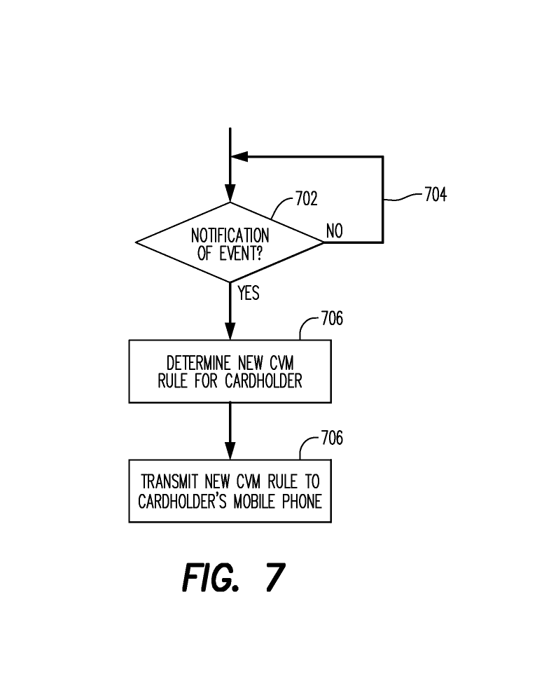

As noted above, the CVM rule that has been stored in the mobile telephone 102 upon personalization may be updated in response to subsequent events. FIG. 7 is a flow chart that illustrates a process that may be performed by the issuer server 104 to perform such an update in accordance with aspects of the present invention.

The process of FIG. 7 begins with a decision block 702. At decision block 702, the issuer server 104 determines whether it has received a notification of an event that calls for updating the CVM rule that has previously been stored in the mobile telephone 102. For example, such an event may include the issuer server 104, or a related computer, detecting a suspicious pattern of purchases in the transactions that are being charged to the cardholder's account.

If no such notification is received, the process of FIG. 7 idles at decision block 702, as indicated by branch 704 from decision block 702. However, if the issuer server 104 determines that it has received such a notification, then the process of FIG. 7 advances from decision block 702 to block 706. At 706, the issuer server 104 determines a new (updated) CVM rule that is to be loaded into the mobile telephone 102. For example, the new CVM rule may provide that CVM is to be required for all transactions, or that a lower transaction amount limit is to be set, such that transactions above the limit will require CVM to be performed.

Then, at 708, the issuer server 104 transmits the new CVM rule to the mobile telephone 102 for loading into the mobile telephone 102. It may be preferable for this to be done expeditiously, e.g., via an immediate OTA data communication session initiated by the issuer server 104.

In example embodiments described above, a CVM rule is stored and applied in a payment-enabled mobile telephone. However, the principles of the invention are also applicable to other types of payment devices, including payment-enabled PDAs or music players, as well as to contactless or contact payment IC cards.

Up to this point, storing and applying CVM rules in a mobile device has been described in connection with purchase transactions that are performed in person. However, in some embodiments, a mobile device may also store and apply a CVM rule in connection with remote payments/transactions implemented with a mobile device, or other types of transactions in which the mobile device does not transmit an account number to a POS/proximity reader. For example, certain in person transactions in which the user enters a pseudo-PAN into a POS terminal and approves the transaction via his/her mobile telephone are described in commonly-assigned and co-pending U.S. patent application Ser. No. 12/323,016, which is incorporated herein by reference. As another example, a user may input his/her mobile telephone number into a merchant's online store webpage; the merchant may submit the mobile telephone number in a purchase transaction authorization request to a payment system; the payment system may contact the user via his/her mobile telephone for transaction approval and authentication (cardholder verification); and the payment system may then translate the user's mobile telephone number into the user's payment card account number which represents a payment card account to which the transaction is charged. The principles of the present invention in regard to storing and applying a CVM rule in a mobile device are applicable to the example transactions described in this paragraph.

The term “CVM rule” is used herein interchangeably with the term “cardholder verification rule”.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, the term “OTA” or “over-the-air” should be understood to refer to an exchange of data messages via at least one mobile telephone network, and more specifically calls for transmission of data (in either or both directions) between a mobile telephone and a cellular communications base station.

As used herein and in the appended claims, the term “OTA transaction” refers to an exchange of information over the air between a mobile telephone and a remote computer.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions and operated under the name of MasterCard, Visa, American Express, Diners Club, Discover Card or a similar system. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a cardholder device from a server computer, at least one cardholder verification rule that prescribes circumstances under which a cardholder is required to perform a cardholder verification process in connection with a purchase transaction;
storing, by the cardholder device, the at least one cardholder verification rule;
receiving, by the cardholder device from a merchant device, purchase transaction information;
determining, by the cardholder device using the stored at least one cardholder verification rule, and based on at least one of the received purchase transaction information and current circumstances, that cardholder verification is not required; and
uploading, by the cardholder device to the merchant device, payment information to complete the purchase transaction.

2. The method of claim 1, further comprising:
receiving, by the cardholder device from the server computer, at least one updated cardholder verification rule due to at least one changed condition;
storing, by the cardholder device, the at least one updated cardholder verification rule; and
determining, by the cardholder device when next conducting a purchase transaction, using the stored at least one updated cardholder verification rule, and based on at least one of the received purchase transaction information and then current circumstances, whether cardholder verification is required during the purchase transaction.

3. The method of claim 2, wherein the cardholder device receives the at least one updated cardholder verification rule in an over-the-are (OTA) transmission from the server computer.

4. The method of claim 2, wherein the at least one changed condition comprises a suspicious pattern in purchase transactions for an account associated with the cardholder device.

5. The method of claim 2, wherein the at least one updated cardholder verification rule requires the cardholder to perform a cardholder verification process for all purchase transactions.

6. The method of claim 1, wherein uploading the payment information comprises transmitting at least one of a payment card account number, a pseudo primary account number (pseudo PAN), and a cardholder mobile telephone number.

7. The method of claim 1, wherein receiving the purchase transaction information comprises receiving at least one of a monetary amount, a type of transaction, a category of merchant, and an identity of a merchant.

8. The method of claim 1, wherein the current circumstances comprises at least one of a current location of the cardholder device, a current time of day, a current day of the week, and a date.

9. The method of claim 1, wherein the current circumstances comprises at least one of a cumulative monetary amount of transactions performed by the cardholder device within a predetermined period, and a cumulative number of transactions performed by the cardholder device within a predetermined period,

10. The method of claim 1, further comprising, subsequent to receiving the purchase transaction information, transmitting, by the cardholder device to the merchant device, instructions configured to cause the merchant device to overrule a merchant device cardholder verification rule in favor of the at least one cardholder verification rule.

11. The method of claim 1, further comprising, subsequent to receiving the purchase transaction information:
determining, by the cardholder device, using the stored at least one cardholder verification rule, and based on at least one of the received purchase transaction information and current circumstances, that cardholder verification is required; and
requiring, by the cardholder device, the cardholder to provide to the merchant device at least one of a personal identification number (PIN) and biometric data.

12. The method of claim 1, wherein the cardholder device comprises one of a mobile telephone, a payment integrated circuit (IC) card, a payment-enabled personal digital assistant (PDA), and a payment-enabled music player.

13. A payment device comprising:
a processor;
receive and transmit circuitry operatively coupled to the processor; and
a memory operatively coupled to the processor, the memory storing at least one cardholder verification rule and instructions configured to cause the processor to:
receive from a server computer, at least one cardholder verification rule that prescribes circumstances under which a cardholder is required to perform a cardholder verification process in connection with a purchase transaction;
store the at least one cardholder verification rule in the memory;
receive from a merchant device, purchase transaction information;
determine, using the stored at least one cardholder verification rule, and based on at least one of the received purchase transaction information and current circumstances, that cardholder verification is not required; and
upload to the merchant device payment information to complete the purchase transaction.

14. The payment device of claim 13, wherein the memory stores further instructions configured to cause the processor to:
receive from the server computer, at least one updated cardholder verification rule due to at least one changed condition;
store the at least one updated cardholder verification rule in the memory; and
determine, when next conducting a purchase transaction, using the stored at least one updated cardholder verification rule, and based on at least one of the received purchase transaction information and then current circumstances, whether cardholder verification is required during the purchase transaction.

15. The payment device of claim 14, wherein the received at least one updated cardholder verification rule comprises instructions configured to cause the processor to require the cardholder to perform a cardholder verification process for all purchase transactions.

16. The payment device of claim 13, wherein the instructions for uploading the payment information to the merchant device comprises instructions configured to cause the processor to transmit at least one of a payment card account number, a pseudo primary account number (pseudo PAN), and a cardholder mobile telephone number.

17. The payment device of claim 13, wherein the instructions for receiving the purchase transaction information comprises instructions configured to cause the processor to receive at least one of a monetary amount, a type of transaction, a category of merchant, and an identity of a merchant.

18. The payment device of claim 13, further comprising, subsequent to receiving the purchase transaction information, instructions configured to cause the processor to transmit to the merchant device instructions configured to cause the merchant device to overrule a merchant device cardholder verification rule in favor of the at least one cardholder verification rule.

19. The payment device of claim 13, further comprising, subsequent to receiving the purchase transaction information, instructions configured to cause the processor to:
determine using the stored at least one cardholder verification rule, and based on at least one of the received purchase transaction information and current circumstances, that cardholder verification is required; and
require the cardholder to provide to the merchant device at least one of a personal identification number (PIN) and biometric data.

20. The payment device of claim 13, wherein the payment device comprises one of a mobile telephone, a payment integrated circuit (IC) card, a payment-enabled personal digital assistant (PDA), and a payment-enabled music player.
